(19) United States
(12) Patent Application Publication
(10) Pub. No.: US 2015/0369297 A1
(43) Pub. Date: Dec. 24, 2015

(54) Elastic Coupling

(71) Applicant: RINGFEDER POWER TRANSMISSION TSCHAN GMBH, Neunkirchen (DE)

(72) Inventors: Simon Graf, Friedrichsthal (DE); Günter Lamber, Neunkirchen (DE)

(73) Assignee: RINGFEDER POWER TRANSMISSION TSCHAN GMBH, Neunkirchen (DE)

(21) Appl. No.: 14/765,044

(22) PCT Filed: Jan. 14, 2014
(86) PCT No.: PCT/EP2014/050613

§ 371 Date: Jul. 31, 2015

(30) Foreign Application Priority Data
Feb. 1, 2013 (DE) 10 2013 101 069.5

(51) Int. Cl. F16D 3/76; F16D 3/56

(52) U.S. Cl. CPC F16D 3/76; F16D 3/56

(57) ABSTRACT

An elastic coupling, in particular an elastic shaft coupling, includes a metallic outer part, a metallic inner part and elastic buffers arranged so as to be spaced apart between the outer part and the inner part. The outer part includes radially inwardly projecting elevations which define buffer contact surfaces and the inner part includes radially outwardly projecting elevations which define buffer contact surfaces. In order for the elastic coupling to allow for gentler startup and an operating behaviour optimized in terms of rotary oscillation in comparison with conventional couplings of this type. The elastic buffers are arranged in at least two groups which are radially spaced apart. At least one annular intermediate part is arranged between the adjacent buffer groups and is connected torsionally to both the outer part and to the inner part via the elastic buffers.

The invention relates to an elastic coupling, in particular an elastic shaft coupling, comprising a metallic outer part, a metallic inner part and elastic buffers arranged so as to be spaced apart between the outer part and the inner part, the outer part comprising radially inwardly projecting elevations which define buffer contact surfaces and the inner part comprising radially outwardly projecting elevations which define buffer contact surfaces.

Couplings of this type are known in practice, for example under the ROLLASTIC brand. The known coupling can compensate an axial, a radial, and also an angular offset of the shafts to be coupled. When the torque is transmitted, all of the elastic buffers are loaded. The coupling makes simple separation of the drive from the associated work machine possible without the drive shaft and the driven shaft having to be pulled apart axially for this purpose. It is merely necessary to release a securing ring from an associated annular groove of the shaft hub, to displace axially the securing ring and an annular alignment disc fixable thereby, and to eject the buffers from the recesses thereof defined by the outer part and the inner part.

The known coupling of the ROLLASTIC type of construction is suitable for many applications, in particular for driving conveyers, crushers, mills, roller tables, mixers, stirring systems, high-pressure pumps and compressors. This coupling has been found to be highly expedient in many applications. Nevertheless, a coupling of this type could still be improved in relation to use at high rotary oscillations and relatively large masses to be accelerated and heavy impacts, so as to protect the connected unit from excessive rotary oscillations and critical dynamic loads.

On this basis, the object of the present invention is to provide a torsionally resilient coupling which makes possible a gentler startup and an operating behaviour optimized in terms of rotary oscillation by comparison with conventional couplings of the aforementioned type.

To achieve this object, a coupling having the features of claim 1 is proposed. Preferred and advantageous embodiments of the coupling according to the invention are specified in the dependent claims.

The coupling according to the invention is characterised in that the elastic buffers are arranged in at least two groups (rows) which are radially spaced apart from each other, at least one annular intermediate part being arranged between the adjacent buffer groups (rows) and being connected torsionally resiliently both to the outer part and to the inner part via the elastic buffers.

As a result of the elastic buffers being arranged in at least two groups (rows) which are radially spaced apart from each other, in other words along at least two substantially coaxial rings, preferably circles, which are radially spaced apart, the torsional rigidity of the coupling can be freely adjusted in a relatively wide range and thus variably adapted to the requirements of the respective application.

In particular, the coupling according to the invention offers the option of adapting the torsional rigidity thereof to the respective operating conditions by arranging elastic buffers of different Shore hardness, size and/or shape on the radially spaced annular regions. A preferred embodiment of the coupling according to the invention accordingly provides that the groups of elastic buffers differ from one another in the material, size and/or shape of the elastic buffers. In particular, the elastic buffers of one group may differ from the elastic buffers of (one of) the other group(s), also in respect to their length.

By comparison with a conventional, generic coupling, for example the known coupling of the ROLLASTIC type of construction, the coupling according to the invention has a much wider adjustment range, so as to change the torsional rigidity of the coupling or achieve an operating behaviour which is low in rotary oscillations.

The elastic buffers are for example substantially made of synthetic and/or natural elastomers and/or or non-thermoplastic polyurethane. The hardness thereof is for example in the range of from 50 to 98 Shore A, preferably in the range of from 55 to 95 Shore A. They may contain conductive material (antistatics), for example carbon and/or metal particles, so as to prevent electrostatic charges in the buffer material and the surroundings of the buffer material. Alternatively, however, the elastic buffers may also be electrically insulating.

The elastic buffers of at least one of the buffer groups are preferably substantially rotationally symmetrical, for example cylindrical, barrel-shaped or spherical.

The coupling according to the invention may comprise two or else more than two radially spaced buffer groups.

A further preferred embodiment of the coupling according to the invention is characterised in that the elastic buffers of an inner group or the inner group are harder and/or have a smaller diameter than the elastic buffers of an outer group or the outer group. As a result, a particularly gentle startup and an operating behaviour which is particularly low in rotary oscillations of the units coupled using the coupling can be achieved. Preferably, the inner part of the coupling should be connected to the work machine to be driven and the outer part to the driving power machine. However, the elastic buffers of an inner group or the inner group need not necessarily be harder than the elastic buffers of an outer group or the outer group; they may also be substantially equally hard or softer than the latter.

In a further preferred embodiment, the annular intermediate part arranged between two adjacent groups of elastic buffers comprises radially inwardly projecting elevations and radially outwardly projecting elevations, the respective inwardly and outwardly projecting elevations defining buffer contact surfaces or positive-fit surfaces. This embodiment is advantageous in relation to changing a group of buffers for harder or softer buffers without the buffers of the other group(s) having to be changed in this case.

The annular intermediate part of the coupling according to the invention may also be referred to as a star-shaped intermediate part.

The annular intermediate part is preferably made of plastics material or light metal, for example of aluminium or an aluminium alloy. As a result, the weight of the coupling according to the invention can be reduced or at least limited to a predetermined total weight. Further, the annular intermediate part can be produced more simply in this case, since a plastics material or light metal workpiece (starting workpiece) can more easily be machined by cutting than for example a steel workpiece. However, the at least one annular intermediate part of the coupling according to the invention may also be made of a metal other than light metal, in particular of steel.

A further advantageous embodiment of the coupling according to the invention provides that the annular intermediate part is assembled from at least two axially separable parts. This embodiment facilitates the mounting of the elastic buffers. The at least two axially separable parts are optionally provided with connecting means, in such a way that they can be releasably interconnected. The releasable connection means may for example be configured as a screw connection or releasable latch connection. Alternatively, the annular intermediate part may also be configured in a single piece. The elastic buffers and the annular intermediate piece are preferably separately produced components which are interconnected with a positive fit rather than being integrally bonded in the coupling according to the invention.

However, in an alternative embodiment of the coupling according to the invention, the annular intermediate part may also be integral with one or both of the adjacent groups of elastic buffers. This embodiment is advantageous regarding rapid and complete mounting of the elastic buffers.

Further, with regard to as uniform an oscillation damping as possible for a compact construction of the coupling, it is favourable if according to a further preferred embodiment of the invention the groups or at least two of the groups comprise the same amount of elastic buffers.

A further advantageous embodiment of the coupling according to the invention is characterised in that the elastic buffers of one of the groups are arranged offset in the circumferential direction relative to the elastic buffers of the adjacent, radially spaced group. This embodiment makes possible a particularly compact construction of the coupling according to the invention.

Another further embodiment of the coupling according to the invention involves it being provided with a mass damper. The mass damper is preferably formed in such a way that the spring constant or torsional spring constant thereof can be adjusted to a frequency to be damped or cancelled out.

Preferably, the mass damper comprises rubber-resilient elements as springs and an annular body as a mass, the rubber-resilient elements being arranged in clearances formed both in the outer surface of the outer part and in the inner surface of the annular body. This embodiment of the mass damper is convenient to implement in terms of production, and makes possible simple adjustment of the mass damper in relation to a frequency to be damped or cancelled out.

In the following, the invention is explained in greater detail by way of drawings which show a plurality of embodiments and in which, schematically:

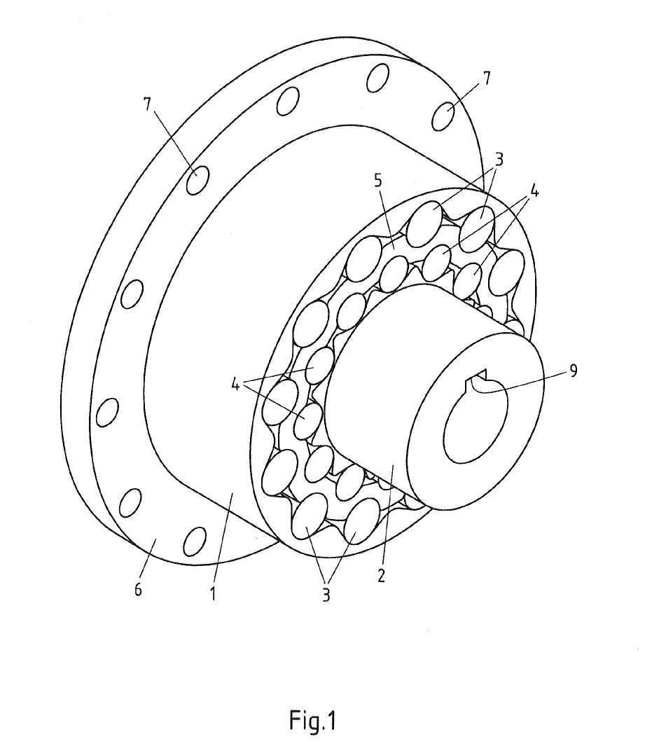

FIG. 1 is a perspective view of a coupling according to the invention;

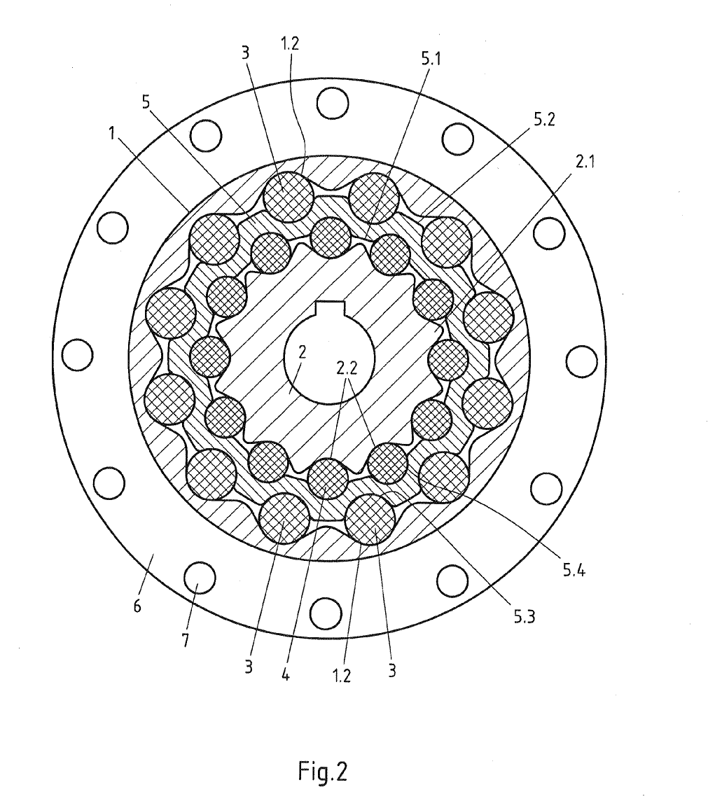

FIG. 2 is a sectional view of the coupling of FIG. 1, the sectional plane extending perpendicularly to the axis of rotation of the coupling and at a distance from the connection flange thereof;

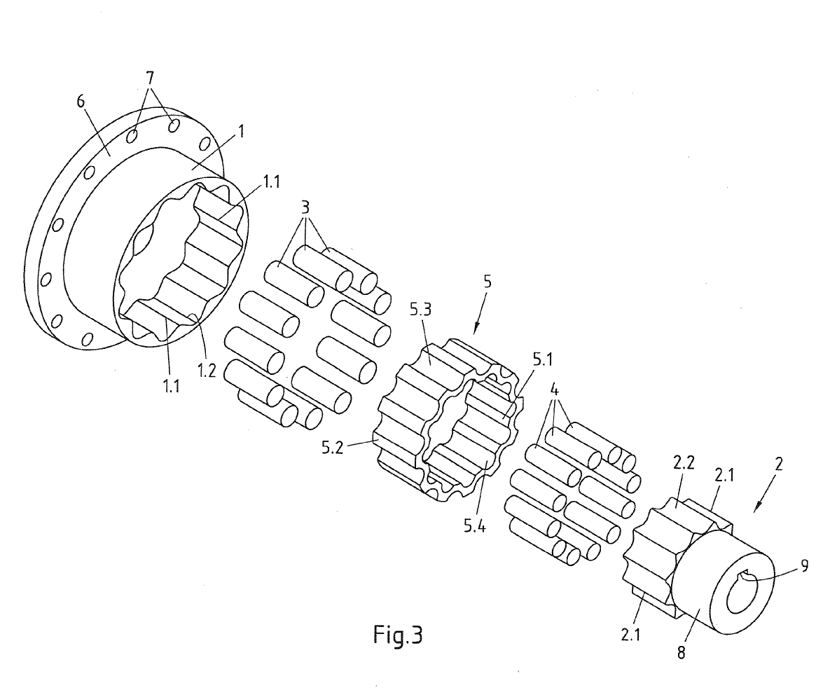

FIG. 3 is an exploded view of the coupling of FIG. 1;

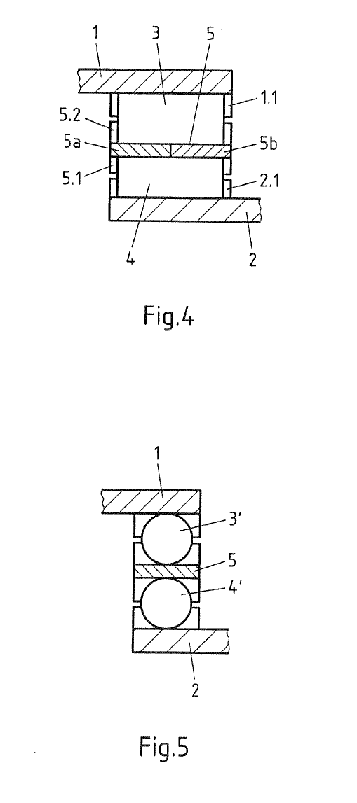

FIG. 4 is a sectional representation of a portion of a coupling according to the invention comprising buffers which are radially spaced apart from each other;

FIG. 5 is a sectional representation of a portion of a further coupling according to the invention comprising buffers which are radially spaced apart from each other;

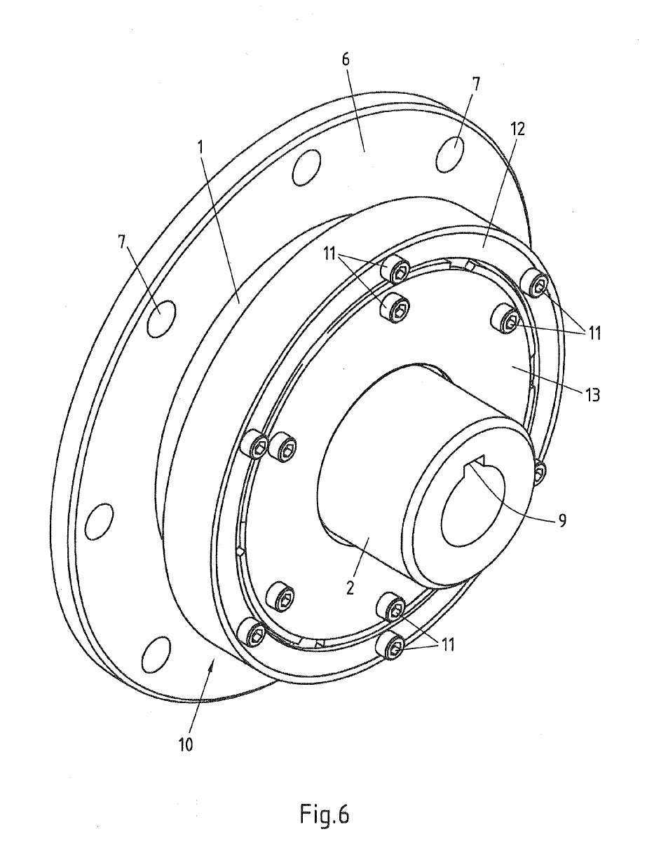

FIG. 6 is a perspective view of a coupling according to the invention comprising a mass damper; and

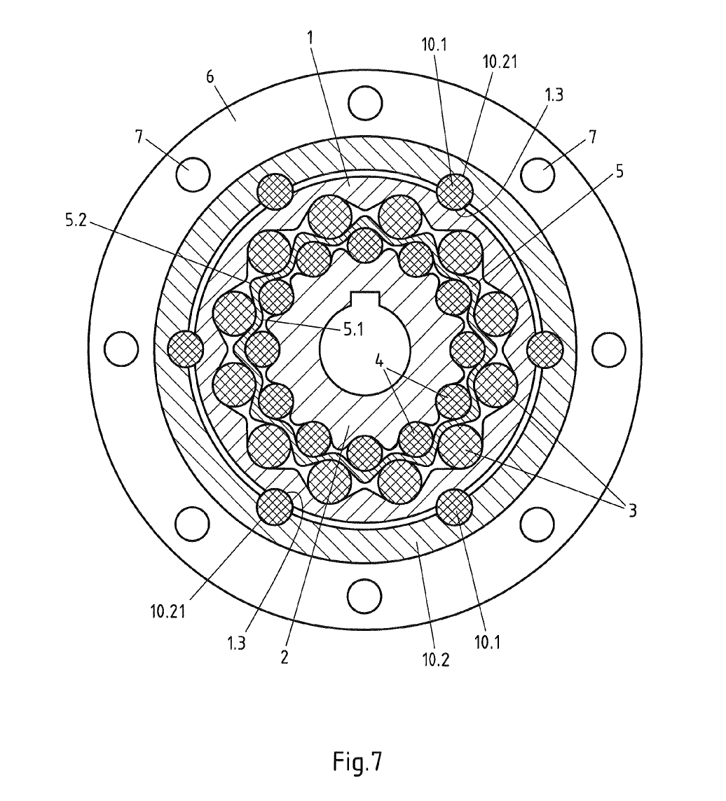

FIG. 7 is a sectional view of the coupling of FIG. 6, the sectional plane extending perpendicularly to the axis of rotation of the coupling and at a distance from the connection flange thereof.

The elastic coupling shown in FIGS. 1 to 3 is provided for example for use in driven transmission shafts. It is constructed from a metallic outer part 1, a metallic inner part 2, a plurality of elastic buffers 3, 4 and an annular intermediate part 5. The outer part 1 is provided with a flange 6 which comprises a plurality of holes 7 to fix screws. The inner part 2 comprises a hub 8, which comprises for example a groove 9 for receiving an inlay key connected to a shaft to be driven. However, the connection of the outer part 1 and the inner part 2 to the shafts to be coupled may also be configured in another way, in particular also using a frictional connection.

The elastic buffers 3, 4 are arranged in two groups (rows) which are spaced apart radially. The annular intermediate part 5, which is made of plastics material or metal, preferably from light metal, is arranged between the buffer groups. The annular intermediate part 5 is star-shaped (cf. also FIG. 7).

The outer part 1 comprises radially inwardly projecting elevations 1.1 which define buffer contact surfaces or positive-fit surfaces. Likewise, the inner part 2 and the annular intermediate part 5 comprise radially inwardly and outwardly projecting elevations 2.1, 5.1, 5.2 which define buffer contact surfaces or positive-fit surfaces. The elevations 1.1, 2.1, 5.1, 5.2 of the outer part, the intermediate part and the inner part delimit trough-shaped recesses 1.2, 2.2, 5.3, 5.4, which are for positively receiving the buffers 3, 4. The annular intermediate part 5 is rotatable relative to the outer part 1 and the inner part 2 counter to the force of the resiliently compressible buffers 3, 4. It is thus not torsionally rigidly connected to either the outer part 1 or the inner part 2.

The trough-shaped recesses 1.2, 2.2, 5.3, 5.4 and accordingly the buffers 3, 4 received therein are spaced apart from each other and arranged so as to be substantially uniformly distributed over the circumference of the outer part 1 or inner part 2. It can clearly be seen in FIG. 2 that the buffers 3 of one group (row) are arranged offset in the circumferential direction relative to the buffers 4 of the other group (row). Preferably, the buffers 3 of one group are arranged substantially centrally between the buffers 4 of the other group (cf. FIG. 2).

In the embodiment shown in FIGS. 1 to 3, the buffers 4 of the inner group differ from those (3) of the outer group in size. The buffers 4, which in this case are substantially cylindrical, of the inner group have a much smaller diameter than the substantially cylindrical buffers 3 of the outer group. Further, the buffers 4 of the inner group preferably also differ from those (3) of the outer group in material or hardness. The buffers 4 of the inner group are preferably much harder than the buffers 3 of the outer group. For example, the buffers 4 of the inner group each have a hardness in the range of from 85 to 98 Shore A, while the buffers 3 of the outer group may each have a hardness in the range of from 50 to 80 Shore A. In addition, the buffers 4 of the inner group may also differ from the buffers 3 of the outer group in length. For example, the buffers 4 may each be longer or shorter than the buffers 3.

It can further be seen in FIG. 2 that the inner buffer group and the outer buffer group comprise the same number of buffers 3 or 4. In the embodiment shown, the two buffer groups each comprise twelve elastic buffers 3 or 4. However, the number of buffers in the respective group (row) may also be more or less than twelve.

For axially securing the buffers 3, 4 and the annular intermediate part 5, an annular groove (not shown) for fixing a securing ring, for example a Seeger circlip ring, may be formed in the outer surface of the hub 8 of the inner part 2. The annular groove and the securing ring (not shown) which can be inserted into it are sufficiently spaced apart from the radially projecting elevations 2.1 of the inner part 2 that an annular alignment disc (not shown) can be arranged with axial play between the securing ring fixed in the annular groove and the tooth-like elevations 2.1. The annular alignment disc extends radially approximately from the outer surface of the hub 8 to the level of the radially inwardly projecting elevations 1.1 of the outer part 1.

The buffers 3, 4 of the coupling can be replaced without displacing the coupled units.

To simplify the mounting of the buffers 3, 4, the annular intermediate part 5 may be configured in a plurality of parts. In the embodiment sketched in FIG. 4, the annular intermediate part 5 is configured in two parts.

Optionally, the two parts 5a, 5b of the intermediate parts 5 may be releasably interconnected. The releasable connection of the two parts 5a, 5b is for example implemented using mutually aligned holes (not shown) which extend axially therein and receive the fixing screws.

Instead of cylindrical or barrel-shaped buffers 3, 4, the coupling according to the invention may also be formed to receive differently shaped buffers, for example spherical buffers 3′, 4′ (cf. FIG. 5).

FIGS. 6 and 7 show a coupling according to the invention comprising a mass damper 10. The elastic coupling of FIGS. 6 and 7 basically corresponds to the coupling shown in FIGS. 1 to 3, and so to avoid repetition reference is made to the above description of the coupling in this respect. The coupling according to the invention forms a dynamic oscillation system, in which resonances can potentially occur. The mass damper 10 provides damping or cancelling out of these resonances or of corresponding resonant frequencies. For this purpose, the mass damper 10 comprises rubber-resilient elements 10.1 as springs and an annular body 10.2 as a mass. The mass damper 10 thus forms a spring-mass system which generates an oscillation counter to a resonance oscillation. The rubber-resilient elements 10.1 are arranged in clearances 1.3, 10.21 which are formed both in the outer surface of the outer part 1 of the coupling and in the inner surface of the annular body 10.2 of the mass damper. The annular body 10.2 encloses the outer surface of the outer part 1 at a radial distance. The clearances 1.3 and rubber-resilient elements 10.1 are preferably arranged so as to be uniformly distributed over the circumference of the outer part 1. Preferably, the clearances 1.3 are positioned opposite some of the radially inwardly projecting elevations 1.1 of the outer part 1. The rubber-resilient elements 10.1 are rotationally symmetrical, preferably cylindrical. The trough-shaped clearances 1.3 in the outer part 1 start or open at the end face of the outer part remote from the flange 6 and end at a distance from the flange 6. Correspondingly, the clearances 10.21 in the annular body 10.2 start or open at the end face of the annular body 10.2 remote from the flange 6 and end at a distance from the opposite end face of the annular body 10.2. In the end face of the outer part 1 remote from the flange 6 and in the end face of the annular body 10.2 remote from the flange 6, threaded holes are provided for receiving screws 11 for fixing securing rings 12, 13. The securing rings 12, 13 are arranged coaxially and radially spaced apart. The inner securing ring 13 is for axially securing the elastic buffers 3, 4, the annular intermediate part 5, and the rubber-resilient elements 10.1, while the outer securing ring 12 is for axially securing the rubber-resilient elements 10.1 and the annular body 10.2 of the mass damper 10.

By replacing the rubber-resilient elements 10.1 for elements of this type having a different Shore hardness, the torsional spring constant of the mass damper 10 can be adjusted in a simple manner to the frequency to be damped or cancelled out. Alternatively or in addition, the annular body 10.2 may also be replaced with a similar body of larger or smaller mass for this purpose.

The implementation of the invention is not limited to the above-disclosed embodiments.

Rather, the accompanying claims include a number of further configurations which also make use of the invention but in a configuration differing from the embodiments shown. Thus, the coupling according to the invention may for example also comprise more than two radially spaced buffer groups. Moreover, it is within the scope of the invention to form the annular intermediate part 5 integrally with one or both of the adjacent groups of elastic buffers 3, 4 (3′, 4′), the intermediate part 5 in this case likewise being produced from synthetic or natural elastomer or from non-thermoplastic polyurethane.

1. Elastic coupling, in particular elastic shaft coupling, comprising a metallic outer part (1), a metallic inner part (2) and elastic buffers (3, 4; 3′, 4′) arranged so as to be spaced apart between the outer part and the inner part, the outer part (1) comprising radially inwardly projecting elevations (1.1) which define buffer contact surfaces and the inner part (2) comprising radially outwardly projecting elevations (2.1) which define buffer contact surfaces, characterised in that the elastic buffers (3, 4; 3′ 4′) are arranged in at least two groups which are radially spaced apart form each other, at least one annular intermediate part (5) being arranged between the adjacent buffer groups and being connected torsionally resiliently both to the outer part (1) and to the inner part (2) via the elastic buffers (3, 4; 3′, 4′).

2. Coupling according to claim 1, characterised in that the groups of elastic buffers (3, 4; 3′, 4′) differ from one another in the material, size and/or shape of the elastic buffers.

3. Coupling according to either claim 1 or claim 2, characterised in that the elastic buffers (4; 4′) of an inner group or the inner group are harder and/or have a smaller diameter than the elastic buffers (3; 3′) of an outer group or the outer group.

4. Coupling according to any of claims 1 to 3, characterised in that the annular intermediate part (5) comprises radially inwardly projecting elevations (5.1) which define buffer contact surfaces and radially outwardly projecting elevations (5.2) which define buffer contact surfaces.

5. Coupling according to claim 4, characterised in that the annular intermediate part (5) is produced from light metal or plastics material.

6. Coupling according to either claim 4 or claim 5, characterised in that the annular intermediate part (5) is constructed from at least two axially separable parts (5a, 5b).

7. Coupling according to any of claims 1 to 3, characterised in that the annular intermediate part (5) is integral with one or both of the adjacent groups of elastic buffers (3, 4; 3′, 4′).

8. Coupling according to any of claims 1 to 7, characterised in that the elastic buffers (3, 4) are substantially rotationally symmetrical at least in one of the groups.

9. Coupling according to any of claims 1 to 8, characterised in that the elastic buffers (3′, 4′) of at least one of the groups are substantially spherical.

10. Coupling according to any of claims 1 to 9, characterised in that the elastic buffers (3) of one of the groups are arranged offset in the circumferential direction relative to the elastic buffers (4) of the adjacent, radially spaced group.

11. Coupling according to any of claims 1 to 10, characterised by a mass damper (10), the torsional spring constant of which can be adjusted to a frequency to be damped or cancelled out.

12. Coupling according to claim 11, characterised in that the mass damper (10) comprises rubber-resilient elements (10.1) and an annular body (10.2), the rubber-resilient elements (10.1) being arranged in clearances (1.3, 10.21) which are formed both in the outer surface of the outer part (1) and in the inner surface of the annular body (10.2).
